(19) United States
(12) Patent Application Publication
(10) Pub. No.: US 2026/0138898 A1
(43) Pub. Date: May 21, 2026

(54) CAPACITIVE DEIONIZATION DEVICE AND METHOD FOR CONTROLLING CAPACITIVE DEIONIZATION DEVICE

(71) Applicant: Samsung Electronics Co., Ltd., Suwon-si (KR)

(72) Inventors: Sungwon KIM, Suwon-si (KR); Sungpil HONG, Suwon-si (KR); Hyoungkyun KIM, Suwon-si (KR); Youngkyu CHO, Suwon-si (KR); Changhoon OH, Suwon-si (KR); Yumee KIM, Suwon-si (KR)

(21) Appl. No.: 19/419,920

(22) Filed: Dec. 15, 2025

Related U.S. Application Data
(63) Continuation of application No. PCT/KR2025/016664, filed on Oct. 21, 2025.

(30) Foreign Application Priority Data
Nov. 15, 2024 (KR) 10-2024-0163599

(51) Int. Cl. C02F 1/469

(52) U.S. Cl. CPC C02F 1/4691; C02F 2201/004; C02F 2201/005; C02F 2201/46135; C02F 2201/4615; C02F 2303/16; C02F 2303/22

(57) ABSTRACT

A capacitive deionization device comprises: a pair of electrodes; and a controller configured to perform a water softening operation that applies a positive voltage across the pair of electrodes, configured to operate in a power-off mode that short-circuits or open-circuits the pair of electrodes based on termination of the water softening operation, and configured to perform a regeneration operation that applies a negative voltage across the pair of electrodes based on satisfaction of a predetermined condition while operating in the power-off mode.

### CROSS-REFERENCE TO RELATED APPLICATION(S)

This application is a continuation application, claiming priority under 35 U.S.C. § 365(c), of an International application No. PCT/KR2025/016664, filed on Oct. 21, 2025, which is based on and claims the benefit of a Korean patent application number 10-2024-0163599, filed on Nov. 15, 2024, in the Korean Intellectual Property Office, the disclosure of which is incorporated by reference herein in its entirety.

### TECHNICAL FIELD

The disclosure relates to a capacitive deionization device and a control method thereof.

### BACKGROUND ART

A deionization technology is a technology that is widely required across industries, such as removing hardness components from areas with high hardness components such as calcium and magnesium in water, and using the water as drinking or boiler water, or using the water as coolant for power plants or factories.

Capacitive deionization (CDI) technology is an example of a deionization technology, and is a technology that removes ions by adsorbing the ions to an electrode having a high specific surface area using an electrochemical method.

A capacitive deionization device performs a water softening operation that removes ions by moving the ions using an electric field generated in a direction perpendicular to a direction of fluid flowing inside a channel.

When the capacitive deionization device performs the water softening operation, a large number of ions are adsorbed on the electrode, and the ion adsorption rate of the electrodes decreases. Accordingly, after performing the water softening operation, the capacitive deionization device needs to perform a regeneration operation to remove the ions adsorbed on the electrode.

### DISCLOSURE

### Technical Problem

The disclosure is directed to providing a capacitive deionization device capable of saving electric energy consumed in a regeneration operation, and a control method thereof.

Another aspect of the disclosure is directed to providing a capacitive deionization device capable of improving a degree of regeneration of an electrode, and a control method thereof.

Another aspect of the disclosure is to provide a capacitive deionization device capable of performing a regeneration operation using optimal electric energy according to various situations, and a control method thereof.

Another aspect of the disclosure is to provide a capacitive deionization device capable of performing a regeneration operation for an optimal time according to various situations, and a control method thereof.

Another aspect of the disclosure is to provide a capacitive deionization device capable of minimizing an amount of water consumed for regeneration of an electrode, and a control method thereof.

Additional aspects will be set forth in part in the description which follows and, in part, will be apparent from the description, or may be learned by practice of the presented embodiments.

### Technical Solution

One aspect of the disclosure provides a capacitive deionization device including: a pair of electrodes; and a controller configured to perform a water softening operation that applies a positive voltage across the pair of electrodes, configured to operate in a power-off mode that short-circuits or open-circuits the pair of electrodes based on termination of the water softening operation, and configured to perform a regeneration operation that applies a negative voltage across the pair of electrodes based on satisfaction of a predetermined condition while operating in the power-off mode. The product of an operating time of the regeneration operation and a magnitude of the negative voltage is less than the product of an operating time of the water softening operation and a magnitude of the positive voltage.

Another aspect of the disclosure provides a control method of a capacitive deionization device including: performing a water softening operation that applies a positive voltage across a pair of electrodes; operating in a power-off mode that short-circuits or open-circuits the pair of electrodes based on termination of the water softening operation; performing a regeneration operation that applies a negative voltage across the pair of electrodes based on satisfaction of a predetermined condition while operating in the power-off mode. The product of an operating time of the regeneration operation and a magnitude of the negative voltage is less than the product of an operating time of the water softening operation and a magnitude of the positive voltage.

### DESCRIPTION OF DRAWINGS

FIG. 1 illustrates an example of a structure of a capacitive deionization device according to an embodiment of the disclosure.

FIG. 2 is a control block diagram of the capacitive deionization device according to an embodiment of the disclosure.

FIG. 3 is a flowchart illustrating an example of a control method of the capacitive deionization device according to an embodiment of the disclosure.

FIG. 4 illustrates a state in which the capacitive deionization device performs a water softening operation according to an embodiment of the disclosure.

FIG. 5 illustrates a state in which the capacitive deionization device operates in a power-off mode according to an embodiment of the disclosure.

FIG. 6 illustrates a state in which the capacitive deionization device performs a regeneration operation according to an embodiment of the disclosure.

FIG. 7 is a flowchart illustrating a method in which the capacitive deionization device performs the regeneration operation according to different operating conditions according to an embodiment of the disclosure.

FIG. 8 is a view illustrating an example of voltage measured by a voltage sensor over time when the capacitive deionization device performs the regeneration operation based on a first condition being satisfied according to an embodiment of the disclosure.

FIG. 9 is a view illustrating an example of voltage measured by the voltage sensor over time when the capacitive deionization device performs the regeneration operation based on a second condition being satisfied according to an embodiment of the disclosure.

FIG. 10 is a view illustrating an example of voltage measured by the voltage sensor over time when the capacitive deionization device omits the power-off mode and performs the regeneration operation according to an embodiment of the disclosure.

FIG. 11 is a view illustrating another example of voltage measured by the voltage sensor over time when the capacitive deionization device omits the power-off mode and performs the regeneration operation according to an embodiment of the disclosure.

### MODES OF THE INVENTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

When an element is “on” another element, this includes not only when the element is in contact with the other element, but also when there is another element between the two elements.

A capacitive deionization device according to various embodiments may be configured to purify contaminated water to make the water clean. The capacitive deionization device is used in sewage treatment facilities, industrial processes, and water supply systems within homes or offices, and thus the capacitive deionization device may play an important role in environmental protection and human health. Water that is purified to a clean state by the capacitive deionization device may be discharged back into nature, used for cleaning purposes, used as drinking water, or reused in industrial processes, and the like.

According to various embodiments, the capacitive deionization device may include not only household capacitive deionization device such as water purifiers or water softeners, but also industrial capacitive deionization device.

A capacitive deionization device according to one embodiment may purify contaminated water through a capacitive deionization (CDI) technology.

The capacitive deionization method refers to a method of removing ions from contaminated water using the principle of ions being adsorbed and desorbed on a surface of electrodes by electrical force generated between the electrodes. In the disclosure, removing ions from contaminated water may include removing ions substances from the contaminated water.

The capacitive deionization device may include various components such as a plurality of pipes through which water flows, a plurality of valves configured to control a flow of water, and a plurality of electrodes.

The capacitive deionization device may include a housing, electrodes, and ion exchange membranes disposed within the housing. According to a voltage supplied to the electrodes, ions contained in water flowing into the housing may be adsorbed to or desorbed from the electrodes.

According to various embodiments, the capacitive deionization device may further include various components such as a pre-treatment filter for pre-treating raw water and/or a post-treatment filter for filtering the water purified by a water softening operation, once again.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

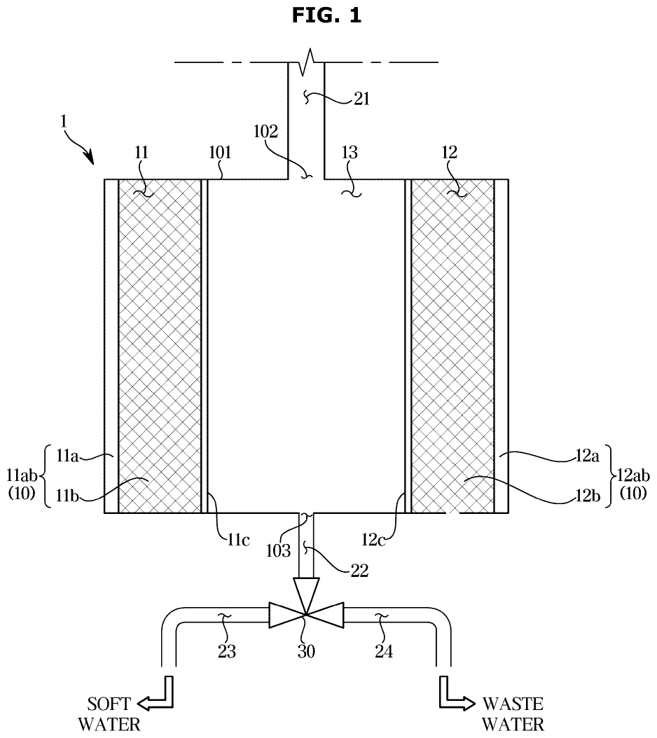

FIG. 1 illustrates an example of a structure of a capacitive deionization device according to an embodiment of the disclosure.

Referring to FIG. 1, a capacitive deionization device 1 according to one embodiment may include a pair of electrodes 10.

The pair of electrodes 10 may include a first electrode 11ab, and a second electrode 12ab.

The first electrode 11ab and the second electrode 12ab may be disposed to face each other.

The first electrode 11ab and the second electrode 12ab may form a capacitor.

A flow path 13 may be formed between the first electrode 11ab and the second electrode 12ab.

The first electrode 11ab may include a first current collector 11a, and a first porous electrode 11b.

The first electrode 11ab may become a positive electrode (anode) in a water softening operation of the capacitive deionization device 1, and the first electrode 11ab may become a negative electrode (cathode) in a regeneration operation.

According to one embodiment, the first current collector 11a may include an electrode plate electrically connected to the first porous electrode 11b. The electrode plate may include a metal plate and/or a non-metallic plate.

The first current collector 11a may be a conductor. For example, a material of the first current collector 11a may be graphite, but the material of the first current collector 11a is not limited thereto.

The first porous electrode 11b may include a solid electrode including a void space. The first porous electrode 11b may be formed of a material that easily adsorbs ions. For example, the first porous electrode 11b may be a carbon porous electrode, but the type of the first porous electrode 11b is not limited thereto.

The second electrode 12ab may include a second current collector 12a, and a second porous electrode 12b.

The second electrode 12ab may become a positive electrode (anode) in the water softening operation of the capacitive deionization device 1, and the second electrode 12ab may become a negative electrode (cathode) in the regeneration operation.

According to one embodiment, the second current collector 12a may include an electrode plate electrically connected to the second porous electrode 12b. The electrode plate may include a metal plate and/or a non-metallic plate.

The second porous electrode 12b may include a solid electrode including a void space. The second porous electrode 12b may be formed of a material that easily adsorbs ions. For example, the second porous electrode 12b may be a carbon porous electrode, but the type of the second porous electrode 12b is not limited thereto.

The capacitive deionization device 1 may include ion exchange membranes 11c and 12c.

The ion exchange membranes 11c and 12c may include an anion exchange membrane 11c provided on the side of the first electrode 11ab that becomes the anode during the water softening operation, and a cation exchange membrane 12c provided on the side of the second electrode 12ab that becomes the cathode during the water softening operation.

The cation exchange membrane 12c may include a membrane that allows only cations to pass through among cations and anions. The cation exchange membrane 12c may have a negative charge. Accordingly, the cation exchange membrane 12c may repel anions and may prevent the anions from passing therethrough, but only allow cations to pass through.

The anion exchange membrane 11c may include a membrane that allows only anions to pass through among cations and anions. The anion exchange membrane 11c may have a positive charge. Accordingly, the anion exchange membrane 11c may repel cations and may prevent the cations from passing therethrough, but only allow anions to pass through.

The ion exchange membranes 11c and 12c may include a synthetic resin membrane.

The capacitive deionization device 1 may include a housing 101 including an inlet 102 and an outlet 103. In one embodiment, at least a portion of a surface of the housing 101 may be provided as the current collectors 11a and 12a. However, at least a portion of the surface of the housing 101 may also be provided as a pad for supporting the current collectors 11a and 12a.

Channels (i.e., flow paths 11, 12, and 13) through which a fluid, which is introduced into an inside of the capacitive deionization device 1 through the inlet 102, flows may be formed between the pair of electrodes 10.

The channels (i.e., flow paths 11, 12, and 13) may include a first flow path 11 formed by the first current collector 11a and the anion exchange membrane 11c, a second flow path 12 formed by the second current collector 12a and the cation exchange membrane 12c, and a third flow path 13 formed by the anion exchange membrane 11c and the cation exchange membrane 12c.

The first flow path 11 may include a space between the first current collector 11a and the anion exchange membrane 11c. The second flow path 12 may include a space between the second current collector 12a and the cation exchange membrane 12c. The third flow path 13 may include a space between the anion exchange membrane 11c and the cation exchange membrane 12c.

The first flow path 11, the second flow path 12, and the third flow path 13 may be replaced by terms such as a channel, a compartment, a space, a room, or a chamber in that the first flow path 11, the second flow path 12, and the third flow path 13 may be distinguished from each other by the ion exchange membranes 11c and 12c.

From a perspective in which water passing through the third flow path 13 during the water softening operation is softened, the third flow path 13 may also be referred to as a water softening flow path.

From a perspective in which most of the water flowing into the capacitive deionization device 1 passes through the third flow path 13, the third flow path 13 may also be referred to as a flow channel.

When a positive voltage is applied across the pair of electrodes 10, the first electrode 11ab becomes a positive electrode (anode) and the second electrode 12ab becomes a negative electrode (cathode). Accordingly, when a positive voltage is applied across the pair of electrodes 10, cations in the third flow path 13 may move to the second flow path 12, and anions in the third flow path 13 may move to the first flow path 11.

Applying a positive voltage across the pair of electrodes 10 may also be referred to as applying water softening voltage or forward voltage across the pair of electrodes 10 in terms of applying voltage for the water softening operation.

Moving cations in the third flow path 13 to the second flow path 12 may include the cations within the third flow path 13 being adsorbed onto the second porous electrode 12b.

Moving anions the third flow path 13 to the first flow path 11 may include the anions within the third flow path 13 being adsorbed onto the first porous electrode 11b.

Applying a positive voltage across the pair of electrodes 10 may include applying a positive voltage across the first current collector 11a and the second current collector 12a.

Applying a positive voltage across the first current collector 11a and the second current collector 12a may include allowing a potential of the first current collector 11a to be higher than a potential of the second current collector 12a.

When a negative voltage is applied across the pair of electrodes 10, the first electrode 11ab becomes a negative electrode (cathode) and the second electrode 12ab becomes a positive electrode (anode). Accordingly, when a negative voltage is applied across the pair of electrodes 10, cations in the second flow path 12 may move to the third flow path 13, and anions in the first flow path 11 may move to the third flow path 13.

Moving cations in the second flow path 12 to the third flow path 13 may include cations, which are adsorbed on the second porous electrode 12b, being desorbed from the second porous electrode 12b.

Moving anions in the first flow path 11 to the third flow path 13 may include anions, which are adsorbed on the first porous electrode 11b, being desorbed from the first porous electrode 11b.

Applying a negative voltage across the pair of electrodes 10 may also be referred to as applying regenerative voltage or reverse voltage across the pair of electrodes 10 in terms of applying a voltage for the regeneration operation.

Applying a negative voltage across the pair of electrodes 10 may include applying a negative voltage across the first current collector 11a and the second current collector 12a.

Applying a negative voltage across the first current collector 11a and the second current collector 12a may include allowing the potential of the first current collector 11a to be lower than the potential of the second current collector 12a.

According to one embodiment, the housing 101 may include the inlet 102 through which water is introduced into the third flow path 13, and the outlet 103 through which water within the third flow path 13 is discharged.

Water outside the capacitive deionization device 1 may be introduced into the third flow path 13 through the inlet 102. Water in the third flow path 13 may be discharged to the outside of the capacitive deionization device 1 through the outlet 103.

The inlet 102 may be connected to a supply flow path 21 connected to a water source from which raw water is supplied from the outside. Water flowing through the supply flow path 21 may be introduced into the third flow path 13.

The outlet 103 may be connected to a discharge flow path 22 connected to the outside of the capacitive deionization device 1. Water flowing through the discharge flow path 22 may flow to either a first discharge flow path 23 or a second discharge flow path 24.

The discharge flow path 22 may guide (or discharge) water, which flows into the third flow path 13, to the outside of the capacitive deionization device 1.

The capacitive deionization device 1 may include a valve 30 configured to block water flowing through the discharge flow path 22 or configured to allow water flowing through the discharge flow path 22 to flow into either the first discharge flow path 23 or the second discharge flow path 24.

The valve 30 may open and close the discharge flow path 22.

The valve 30 may close the discharge flow path 22 to prevent water in the third flow path 13 from being discharged to the outside of the capacitive deionization device 1, or open the discharge flow path 22 to allow water in the third flow path 13 to be discharged to the outside of the capacitive deionization device 1.

The valve 30 may connect the discharge flow path 22 to the first discharge flow path 23 to allow water in the third flow path 13 to be discharged to the first discharge flow path 23, or may connect the discharge flow path 22 to the second discharge flow path 24 to allow water in the third flow path 13 to be discharged to the second discharge flow path 24.

The first discharge flow path 23 may be referred to as a soft water discharge flow path from a perspective in which the first discharge flow path is a flow path through which softened water (or deionized water) is discharged. The second discharge flow path 24 may be referred to as a wastewater discharge flow path from a perspective in which the second discharge flow path is a flow path through which contaminated water (or wastewater) is discharged.

The first discharge flow path 23 may be connected to a device requiring soft water to supply soft water to the device. For example, the device requiring soft water may include home appliances such as washing machines, refrigerators, dishwashers, and water purifiers, but are not limited thereto.

According to various embodiments, the first discharge flow path 23 may be connected to a plurality of devices requiring soft water. For example, the first discharge flow path 23 may be connected to a first home appliance, and a second home appliance different from the first home appliance.

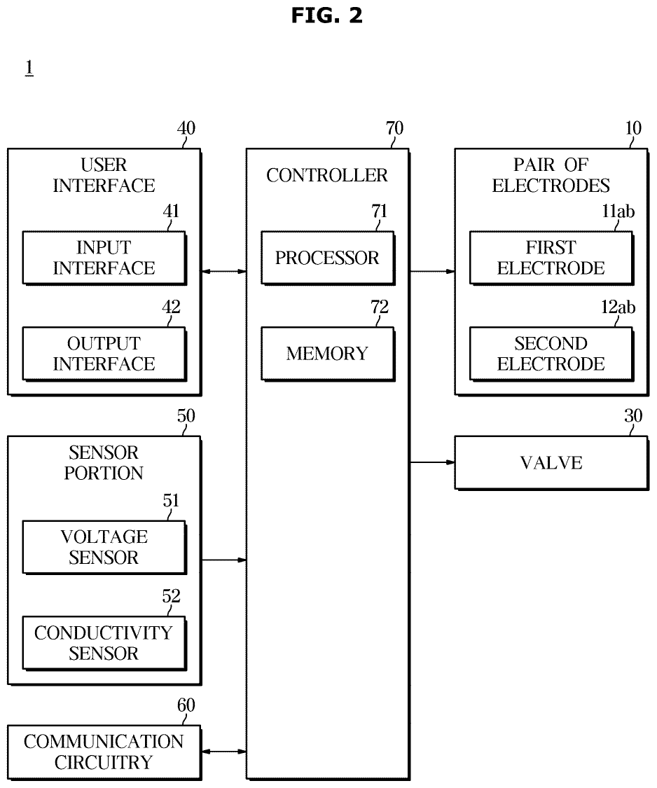

FIG. 2 is a control block diagram of the capacitive deionization device according to an embodiment of the disclosure.

Referring to FIG. 2, the capacitive deionization device 1 according to one embodiment may include a user interface 40, a sensor portion 50, a communication circuitry 60, the pair of electrodes 10, the valve 30, and/or a controller 70.

The user interface 40 may include at least one input interface 41 and at least one output interface 42.

The at least one input interface 41 may convert sensory information received from a user into an electrical signal.

The at least one input interface 41 may include a power input interface for turning on power of the capacitive deionization device 1, an operation input interface for starting an operation of the capacitive deionization device 1, an operation mode selection input interface, and a setting input interface. The at least one input interface 41 may include a tact switch, a push switch, a slide switch, a toggle switch, a micro switch, a touch switch, a touch pad, a touch screen, a jog dial, and/or a microphone.

The at least one input interface 41 may include a water softening start button for starting the water softening operation. When the water softening start button is selected, the capacitive deionization device 1 may perform the water softening operation.

The at least one output interface 42 may transmit various information related to the operation of the capacitive deionization device 1 to a user by generating sensory information.

For example, the at least one output interface 42 may transmit an operating time of the capacitive deionization device 1, information related to the settings of the capacitive deionization device 1, and information obtained from the sensor portion 50, to a user. The information of the capacitive deionization device 1 may be output to a screen, an indicator, a voice, and the like. The at least one output interface 42 may include a liquid crystal display (LCD) panel, a light emitting diode (LED) panel, a speaker, and the like.

The sensor portion 50 may include at least one sensor configured to obtain information related to an operating status of the capacitive deionization device 1.

According to one embodiment, the sensor portion 50 may include various sensors for measuring water quality within the third flow path 13.

For example, the sensor portion 50 may include a water quality sensor for detecting a water quality of water discharged through the outlet 103.

The water quality sensor may include various sensors, such as, a turbidity sensor, a Total Dissolved Solids (TDS) sensor, a pH sensor, an electrical conductivity sensor, a hardness sensor, and a flow sensor.

The water quality sensor may be provided in the discharge flow path 22, the first discharge flow path 23 and/or the second discharge flow path 24 to detect a water quality of water discharged through the outlet 103, but any position for detecting the water quality of water discharged from the capacitive deionization device 1 may be employed as a position of the water quality sensor without limitation.

According to one embodiment, the sensor portion 50 may include a conductivity sensor 52 configured to measure conductivity of water flowing into the third flow path 13.

According to one embodiment, the sensor portion 50 may include a voltage sensor 51 configured to measure a potential difference between the pair of electrodes 10.

Information obtained by the sensor portion 50 may be transmitted to the controller 70.

The capacitive deionization device 1 may include the communication circuitry 60 for communicating with an external device (for example, a server, a user device, and/or a home appliance) via wires and/or wirelessly.

The communication circuitry 60 may include at least one of a short-range communication module or a long-range communication module.

The communication circuitry 60 may transmit data to an external device or receive data from an external device. For example, the communication circuitry 60 may establish communication with a server, a user device, and/or a home appliance, and transmit and receive various types of data.

For the communication, the communication circuitry 60 may establish a direct (for example, wired) communication channel or a wireless communication channel between external devices, and support the performance of the communication through the established communication channel. According to one embodiment, the communication circuitry 60 may include a wireless communication module (for example, a cellular communication module, a short-range wireless communication module, or a global navigation satellite system (GNSS) communication module) or a wired communication module (for example, a local area network (LAN) communication module, or a power line communication module). Among these communication modules, the corresponding communication module may communicate with an external device through a first network (for example, a short-range wireless communication network such as Bluetooth, wireless fidelity (Wi-Fi) direct, or infrared data association (IrDA)) or a second network (for example, a long-range wireless communication network such as a legacy cellular network, a fifth generation (5G) network, a next-generation communication network, the Internet, or a computer network (for example, LAN or WAN). These various types of communication modules may be integrated as one component (for example, a single chip) or implemented as a plurality of separate components (for example, multiple chips).

The short-range wireless communication module may include a Bluetooth communication module, a Bluetooth Low Energy (BLE) communication module, a near field communication module, a wireless LAN (WLAN) (Wi-Fi) communication module, and a Zigbee communication module, an infrared data association (IrDA) communication module, a Wi-Fi Direct (WFD) communication module, an ultrawideband (UWB) communication module, an Ant+communication module, a microwave (uWave) communication module, and the like, but is not limited thereto.

The long-range wireless communication module may include a communication module that performs various types of long-range wireless communication, and may include a mobile communication portion. The mobile communication portion transmits and receives radio signals with at least one of a base station, an external terminal, and a server on a mobile communication network.

According to one embodiment, the communication circuitry 60 may communicate with an external device such as a server, user devices, and home appliances through an access point (AP). The access point (AP) may connect a local area network (LAN), to which the capacitive deionization device 1, home appliances, and/or user devices are connected, to a wide area network (WAN) to which a server is connected. The capacitive deionization device 1, home appliances, and/or user devices may be connected to the server through the wide area network (WAN).

Information obtained by the communication circuitry 60 may be transmitted to the controller 70.

For example, in response to receiving a soft water request signal from an external device (for example, a home appliance), the communication circuitry 60 may transmit the soft water request signal to the controller 70.

The controller 70 may start the water softening operation in response to receiving the soft water request signal from an external device (for example, a home appliance).

The external device (for example, a home appliance) may transmit the soft water request signal to the capacitive deionization device 1 when soft water is needed.

For example, a dishwasher and/or washing machine may transmit a soft water request signal to the capacitive deionization device 1 based on start of a cycle (for example, a washing cycle or a rinsing cycle).

The soft water request signal may include information on a point in time on which soft water is needed.

The controller 70 may control various components of the capacitive deionization device 1 (for example, the user interface 40, the sensor portion 50, the communication circuitry 60, the pair of electrodes 10 and/or the valve 30).

The controller 70 may include hardware such as a CPU, Mi-com, or memory, and software such as a control program. For example, the controller 70 may include at least one memory 72 storing data in the form of a program, and an algorithm for controlling the operation of components in the capacitive deionization device 1, and at least one processor 71 configured to perform the operations described above and operations to be described later using the data stored in the at least one memory 72. The memory 72 and the processor 71 may each be implemented as separate chips. The processor 71 may include one or more processor chips or one or more processing cores. The memory 72 may include one or more memory chips or one or more memory blocks. In addition, the memory 72 and the processor 71 may be implemented as a single chip.

The controller 70 may be electrically connected to the user interface 40, the sensor portion 50, the communication circuitry 60, the pair of electrodes 10 and/or the valve 30.

The controller 70 may control a voltage applied across the pair of electrodes 10. The controller 70 may control the valve 30.

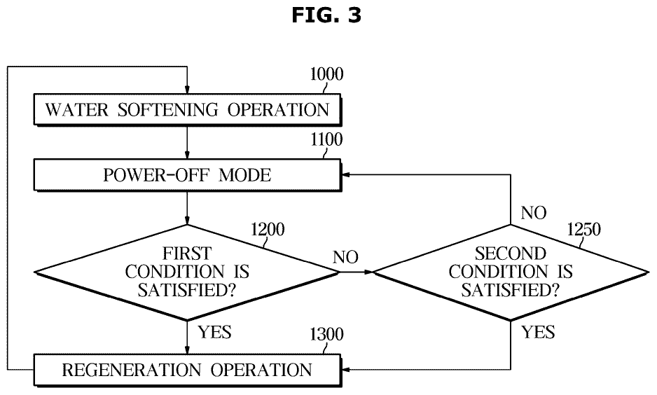

FIG. 3 is a flowchart illustrating an example of a control method of the capacitive deionization device according to an embodiment of the disclosure.

Referring to FIG. 3, the controller 70 may perform the water softening operation based on a water softening start condition being satisfied at operation 1000.

The water softening start condition may include receiving the water softening request signal from an external device (for example, a home appliance), selecting the water softening start button to start the water softening operation, and the like.

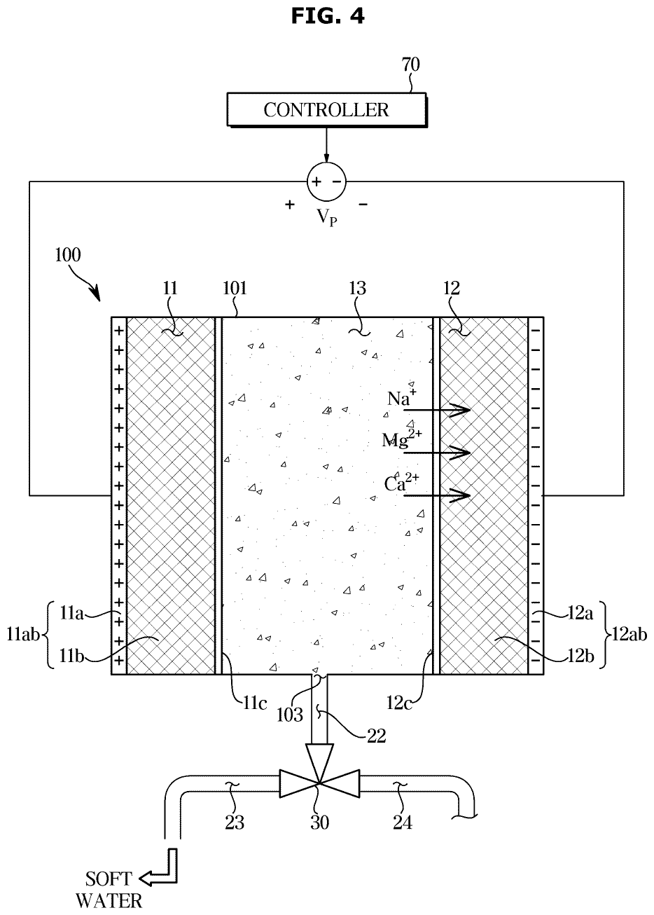

FIG. 4 illustrates a state in which the capacitive deionization device performs a water softening operation according to an embodiment of the disclosure.

Referring to FIG. 4, the controller 70 may perform the water softening operation by applying a positive voltage (Vp) across the pair of electrodes 10.

Applying a positive voltage across the pair of electrodes 10 may include applying the positive voltage (Vp) to the first electrode 11ab. Applying the positive voltage (Vp) across the pair of electrodes 10 may include applying a negative voltage to the second electrode 12ab. Applying the positive voltage (Vp) across the pair of electrodes 10 may include applying a positive voltage to the first electrode 11ab and applying a negative voltage to the second electrode 12ab.

A magnitude of the positive voltage (Vp) applied across the pair of electrodes 10 may mean a size of the potential difference between the first electrode 11ab and the second electrode 12ab.

For example, when +0.6 V is applied to the first electrode 11ab and −0.6 V is applied to the second electrode 12ab, a magnitude of the positive voltage (Vp) applied across the pair of electrodes 10 may be 1.2 V.

The positive voltage (Vp) applied across the pair of electrodes 10 may have a predetermined magnitude. The predetermined magnitude may be preset depending on factors such as a distance between the pair of electrodes 10.

When the positive voltage (Vp) is applied across the pair of electrodes 10, cations contained in the water in the third flow path 13 may move to the second flow path 12.

Cations contained in water may include sodium ions (Na⁺), magnesium ions (Mg²⁺), calcium ions (Ca²⁺), and the like.

The cations contained in the water within the third flow path 13 may be adsorbed onto the second porous electrode 12b by moving to the second flow path 12.

The water softening operation may be referred to as a deionization operation in terms of removing ions contained in the water within the third flow path 13.

The controller 70 may open the discharge flow path 22 during the water softening operation. For example, the controller 70 may control the valve 30 to open the discharge flow path 22 based on the start of the water softening operation. Opening the discharge flow path 22 in the water softening operation may include opening the discharge flow path 22 during a period of the water softening operation.

The controller 70 may control the valve 30 to allow the discharge flow path 22 to communicate with the first discharge flow path 23 based on the start of the water softening operation.

Accordingly, water flowing through the third flow path 13 during the water softening operation may be discharged to the first discharge flow path 23 after ions are removed.

Referring again to FIG. 3, the controller 70 may be operated in a power-off mode (unpowered mode or powerless mode) based on satisfaction of a water softening termination condition at 1100.

That the controller 70 is operated in the power-off mode may include that the controller 70 operates the capacitive deionization device 1 in the power-off mode.

That the controller 70 is operated in the power-off mode may include short-circuiting or open-circuiting the pair of electrodes 10.

The water softening termination condition may include that the operating time of the water softening operation exceeds a predetermined period of time, that electrical conductivity of the water discharged through the outlet 103 during the water softening operation (or electrical conductivity of the water flowing within the third flow path 13) exceeds a predetermined value, and the like. The predetermined period of time may be preset according to factors such as a distance between the pair of electrodes 10, the magnitude of the positive voltage (Vp) applied across the pair of electrodes 10 during the water softening operation, and the like.

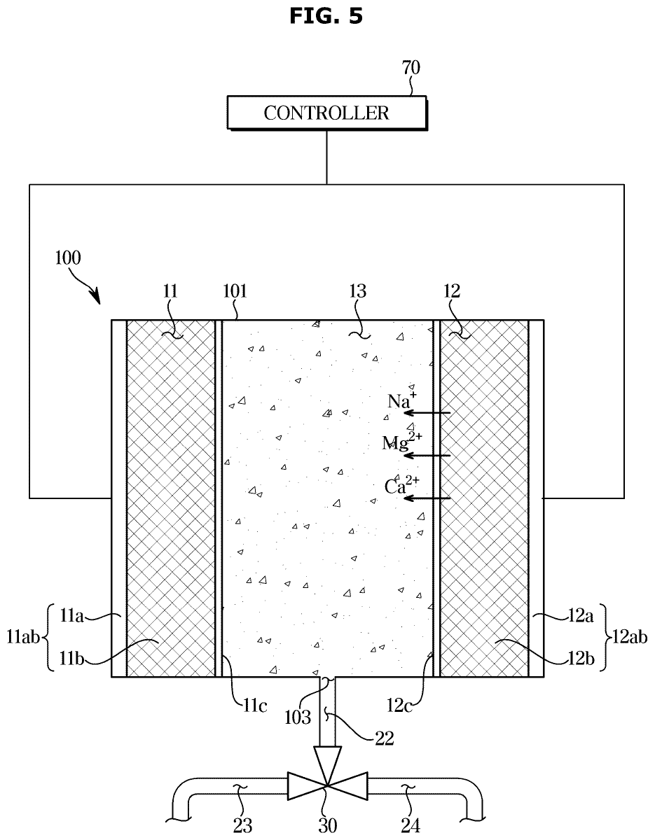

FIG. 5 illustrates a state in which the capacitive deionization device operates in a power-off mode according to an embodiment of the disclosure.

Referring to FIG. 5, the controller 70 may operate in the power-off mode by short-circuiting or open-circuiting the pair of electrodes 10 based on the termination of the water softening operation.

Short-circuiting or open-circuiting the pair of electrodes 10 may include not applying a voltage across the pair of electrodes 10. In this respect, the power-off mode (unpowered mode or powerless mode) may be referred to as a natural regeneration mode, a natural discharge mode, and the like.

According to one embodiment, the controller 70 may operate in the power-off mode by short-circuiting or open-circuiting the pair of electrodes 10 after the water softening operation is terminated. For example, the controller 70 may operate in the power-off mode by short-circuiting or open-circuiting the pair of electrodes 10 immediately after the water softening operation is terminated.

When the positive voltage (Vp) is applied across the pair of electrodes 10 and the pair of electrodes 10 are short-circuited or open-circuited, the capacitor formed by the pair of electrodes 10 is gradually discharged. For example, when the positive voltage (Vp) is applied across the pair of electrodes 10 and the pair of electrodes 10 are short-circuited or open-circuited, a potential difference between the pair of electrodes 10 may gradually decrease.

When the potential difference between the pair of electrodes 10 gradually decreases, the cations adsorbed on the second porous electrode 12b may gradually be desorbed from the second porous electrode 12b. For convenience of description, this phenomenon may be expressed as a natural discharge phenomenon or a natural desorption phenomenon.

An extent, to which cations are desorbed from the second porous electrode 12b when the pair of electrodes 10 are short-circuited or open-circuited, may be less than an extent to which cations are desorbed from the second porous electrode 12b when a negative voltage is applied across the pair of electrodes 10. However, in terms of energy efficiency, the extent, to which cations are desorbed from the second porous electrode 12b when the pair of electrodes 10 is short-circuited or open circuited, may be better not to apply a voltage across the pair of electrodes 10.

The controller 70 may close the discharge flow path 22 in the power-off mode. For example, the controller 70 may control the valve 30 to close the discharge flow path 22 in the power-off mode. Closing the discharge flow path 22 in the power-off mode may include closing the discharge flow path 22 for a period in which the controller 70 operates in the power-off mode.

The controller 70 may control the valve 30 to allow the discharge flow path 22 to communicate with the first discharge flow path 23 based on the termination of the water softening operation (start of operation in the power-off mode).

Accordingly, in the power-off mode, the water in the third flow path 13 may not flow and may remain in the capacitive deionization device 1.

According to the disclosure, by not allowing the flow of water in the third flow path 13 in the power-off mode, ions adsorbed on the porous electrodes 11b and 12b may be efficiently desorbed from the porous electrodes 11b and 12b by the natural desorption phenomenon.

According to the disclosure, by not allowing the flow of water in the third flow path 13 in the power-off mode, it is possible to minimize an amount of water consumed to regenerate the electrode 10.

Referring again to FIG. 3, the controller 70 may perform the regeneration operation 1300 based on a predetermined condition being satisfied (yes in 1200 or yes in 1250) while operating in the power-off mode.

The predetermined condition may include a first condition, and a second condition that is different from the first condition.

The first condition is a condition that may maximize the use of natural desorption phenomenon and may be preset.

According to one embodiment, the first condition may be associated with a potential difference between the pair of electrodes 10 measured by the voltage sensor 51.

For example, the first condition may include that the potential difference between the pair of electrodes 10 measured by the voltage sensor 51 reaches 0 V and/or that a rate of change of the potential difference between the pair of electrodes 10 measured by the voltage sensor 51 reaches 0 (zero).

The rate of change of the potential difference between the pair of electrodes 10 may mean an amount of change in the potential difference between the pair of electrodes 10 per unit time.

According to one embodiment, the controller 70 may perform the regeneration operation in response to the potential difference between the pair of electrodes 10 measured by the voltage sensor 51 reaching 0 V or in response to the amount of the change in the potential difference per unit time reaching 0 (zero) while the controller 70 operates in the power-off mode.

When the potential difference between the pair of electrodes 10 reaches 0 V or the amount of the change in the potential difference per unit time reaches 0 (zero), cations are no longer desorbed from the second porous electrode 12b, but cations tend to be adsorbed to the second porous electrode 12b again.

According to the disclosure, energy efficiency according to the regeneration operation may be maximized by performing the regeneration operation after regenerating the pair of electrodes 10 by maximizing the use of the natural discharge phenomenon. In one embodiment, the predetermined condition may be associated with a period of operating in the power-off mode (operating time of the power-off mode).

According to one embodiment, the first condition may include a condition related to the operating time of the power-off mode.

For example, the first condition may include that the period of operating in the power-off mode (or the operating time of the power-off mode) reaches a threshold period (or threshold time).

The threshold period may be preset as a period that may maximize the use of the natural discharge phenomenon through a plurality of experiments that considers factors such as the operating time of the water softening operation, the magnitude of the positive voltage applied to the pair of electrodes 10 in the water softening operation, the distance between the pair of electrodes 10, and the like.

According to one embodiment, the controller 70 may perform the regeneration operation in response to the period of operating in the power-off mode reaching the threshold period.

Even when the first condition is not satisfied while operating in the power-off mode, the controller 70 may perform the regeneration operation based on satisfaction of the second condition (no in 1200, and yes in 1250).

The second condition, which does not maximize the use of the natural desorption phenomenon, may be preset. The second condition, which is a special condition that does not maximize the use of the natural desorption phenomenon, may also be referred to as a special condition or emergency condition.

The second condition may include a condition related to a start time (or expected start time) of a next water softening operation. The next water softening operation may mean a water softening operation that is performed again after the current water softening operation is terminated.

The capacitive deionization device 1 may receive the soft water request signal from an external device (for example, a home appliance), and the soft water request signal includes information regarding a point in time when soft water is needed. Accordingly, the capacitive deionization device 1 may record data regarding start times of water softening operation in response to receiving the soft water request signal.

The capacitive deionization device 1 generally performs the water softening operation again after a relatively long period of time passes after performing the water softening operation.

For example, when the capacitive deionization device 1 supplies soft water to a dishwasher, the capacitive deionization device 1 performs the water softening operation while the dishwasher performs a first washing cycle, promotes regeneration of electrode while the dishwasher performs a rinsing cycle, and then performs the water softening operation again while the dishwasher performs a second washing cycle. At this time, a time between the first and second washing cycles of the dishwasher may be a sufficient time for the capacitive deionization device 1 to operate in the power-off mode and then to perform the regeneration operation based on satisfaction of the first condition. The sufficient time may be pre-determined through a prior experiment, and in the disclosure, for the convenience of description, this sufficient time is referred to as a reference time.

According to one embodiment, in response to the time between an end time of the water softening operation and a start time of the next water softening operation being greater than or equal to the reference time, the capacitive deionization device 1 may operate in the power-off mode after the water softening operation is terminated, and then perform the regeneration operation based on the satisfaction of the first condition.

On the other hand, depending on special situations, the capacitive deionization device 1 may need to perform the water softening operation again after a relatively short period of time passes after performing the water softening operation.

For example, among a plurality of washing courses that may be performed by an external device (for example, a dishwasher) that receives soft water from the capacitive deionization device 1, some of the washing courses (for example, a rapid course) may correspond to a washing course which has a relatively short time between the first and second washing cycles. As another example, when the capacitive deionization device 1 supplies soft water to a plurality of external devices (for example, a dishwasher, a washing machine, a clothes care apparatus, a refrigerator, a water purifier, and the like), the plurality of home appliances may each request soft water at relatively short time intervals.

As another example, a user can manipulate an external device (for example, a dishwasher) that receives soft water from the capacitive deionization device 1, thereby forcibly reducing the interval between times in which soft water is required. For example, while the dishwasher is performing a washing cycle, a user can request that the dishwasher terminates the cycle, and then immediately thereafter request that the dishwasher start a cycle again. In this case, the time interval between times in which the dishwasher requests soft water from the capacitive deionization device 1 may be substantially short.

As mentioned above, when an external device requests soft water at relatively short time intervals, the capacitive deionization device 1 may not secure the reference time for performing the regeneration operation based on the satisfaction of the first condition, while operating in the power-off mode.

The second condition may include that the start of the next water softening operation is scheduled within the reference time while operating in the power-off mode.

According to various embodiments, the controller 70 may omit the power-off mode in response to the start of the next water softening operation being scheduled within the reference time from the end time of the water softening operation. For example, when the start of the next water softening operation is scheduled within the reference time from the end time of the water softening operation, the controller 70 may perform the regeneration operation immediately after the termination of the water softening operation.

In response to the start of the water softening operation being scheduled within the reference time from the end time of the water softening operation, the controller 70 may determine a magnitude of a negative voltage (Vn) and an operating time of the regeneration operation based on a time interval between the end time of the water softening operation and the start time of the next water softening operation. For example, the controller 70 may set the magnitude of the negative voltage (Vn) to increase and the operating time of the regeneration operation to decrease as the time interval between the end time of the water softening operation and the start time of the next water softening operation decreases.

When the capacitive deionization device 1 does not need to perform the next water softening operation within the reference time, the controller 70 may operate in the power-off mode until the first condition is satisfied. On the other hand, when the capacitive deionization device 1 needs to perform the next water softening operation within the reference time, the capacitive deionization device 1 needs to perform the water softening operation after quickly regenerating the pair of electrodes 10.

According to one embodiment, the controller 70 may perform the regeneration operation based on a time, which remains until the start of the next water softening operation, being less than or equal to the reference time while operating in the power-off mode.

Meanwhile, the reference time may change depending on the operating time of the power-off mode. For example, when the capacitive deionization device 1 operates in the power-off mode for a certain period of time, a time required for the regeneration operation may decrease. As the time required for the regeneration operation decreases, the reference time may increase.

According to one embodiment, the controller 70 may determine the reference time based on the operating time of the power-off mode. For example, the controller 70 may set the reference time to increase as the operating time of the power-off mode increases. However, an increase rate of the reference time that is increased as the operating time of the power-off mode increases may be less than an increase rate of the operating time of the power-off mode.

According to one embodiment, the controller 70 may determine the reference time based on an integral value of the potential difference between the pair of electrodes 10 measured by the voltage sensor 51 while operating in the power-off mode.

The integral value of the potential difference between the pair of electrodes 10 measured by the voltage sensor 51 may mean integrating values of potential difference between the pair of electrodes 10 measured by the voltage sensor 51 over the operating time of the power-off mode.

For example, the controller 70 may set the reference time to increase as the integral value of the potential difference between the pair of electrodes 10 measured by the voltage sensor 51 increases. However, the increase rate of the reference time that is increased as the integral value increases may be less than the increase rate of the operating time of the power-off mode.

The controller 70 may determine that the second condition is satisfied in response to the interval between a current time and the start time of the next water softening operation reaching the reference time while operating in the power-off mode.

According to the disclosure, when it is possible to maximize the use of the natural discharge phenomenon, energy efficiency and regeneration efficiency may be maximized by maximizing the use of the natural discharge phenomenon, and even in special situations in which it is impossible to maximize the use of the natural discharge phenomenon, the regeneration operation may be performed quickly after maximizing the use of the discharge phenomenon.

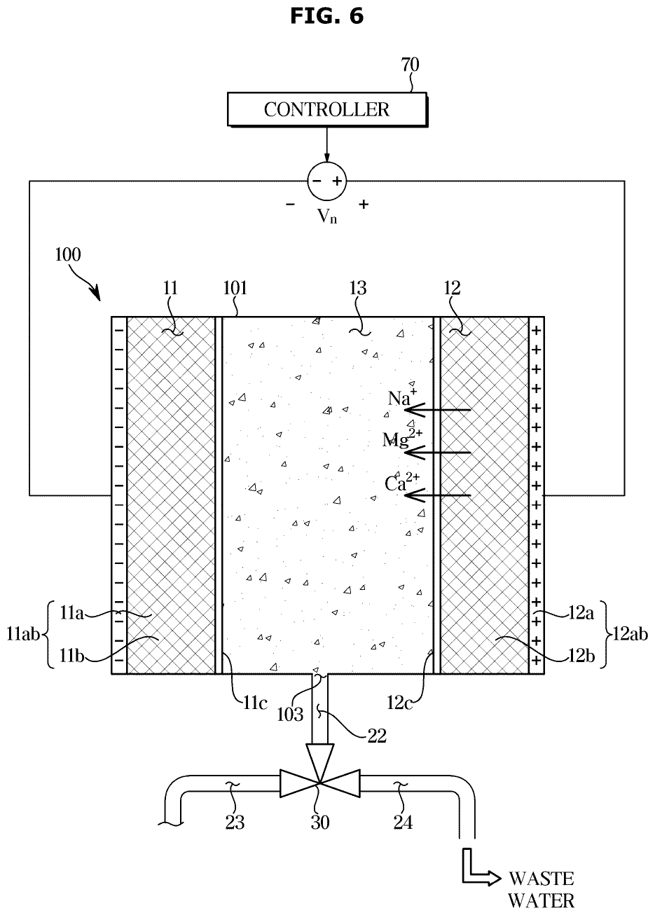

FIG. 6 illustrates a state in which the capacitive deionization device performs a regeneration operation according to an embodiment of the disclosure.

Referring to FIG. 6, the controller 70 may perform the regeneration operation by applying a negative voltage (Vn) to the pair of electrodes 10.

Applying the negative voltage (Vn) across the pair of electrodes 10 may include applying a negative voltage to the first electrode 11ab. Applying the negative voltage (Vn) across the pair of electrodes 10 may include applying a positive voltage to the second electrode 12ab. Applying the negative voltage (Vn) across the pair of electrodes 10 may include applying a negative voltage to the first electrode 11ab and applying a positive voltage to the second electrode 12ab.

A magnitude of the negative voltage (Vn) applied across the pair of electrodes 10 may mean a magnitude of the potential difference between the second electrode 12ab and the first electrode 11ab.

For example, when +0.6 V is applied to the second electrode 12ab and −0.6 V is applied to the first electrode 11ab, the magnitude of the negative voltage (Vn) applied across the pair of electrodes 10 may be 1.2 V.

According to one embodiment, the product of the magnitude of the negative voltage (Vn) applied across the pair of electrodes 10 during the regeneration operation and the operating time of the regeneration operation may be less than the product of the magnitude of the positive voltage (Vp) applied across the pair of electrodes 10 during the water softening operation and the operating time of the water softening operation.

That is, power consumed by the pair of electrodes 10 during the regeneration operation may be less than power consumed by the pair of electrodes 10 during the water softening operation.

From a perspective in which the product of the magnitude of the negative voltage (Vn) applied across the pair of electrodes 10 during the regeneration operation and the operating time of the regeneration operation corresponds to the electric energy (or power) consumed during the regeneration operation, it may be referred to as regenerative energy (or regenerative power).

From a perspective in which the product of the magnitude of the positive voltage (Vp) applied across the pair of electrodes 10 during the water softening operation and the operating time of the water softening operation corresponds to the electrical energy (or power) consumed during the water softening operation, it may be referred to as water softening energy (or water softening power).

The regeneration operation may be referred to as wastewater operation from a perspective in which contaminated water in the third flow path 13 is discharged to the outside.

The controller 70 may open the discharge flow path 22 during the regeneration operation. For example, the controller 70 may control the valve 30 to open the discharge flow path 22 based on the start of the regeneration operation. Opening the discharge flow path 22 in the regeneration operation may include opening the discharge flow path 22 during a period of the regeneration operation.

The controller 70 may control the valve 30 to allow the discharge flow path 22 to communicate with the second discharge flow path 24 based on the start of the regeneration operation.

Accordingly, wastewater flowing through the third flow path 13 during the regeneration operation may be discharged to the second discharge flow path 24.

The controller 70 may terminate the regeneration operation based on satisfaction of a regeneration termination condition. Terminating the regeneration operation may include short-circuiting or open-circuiting the pair of electrodes 10. Terminating the regeneration operation may include closing the discharge flow path 22.

Thereafter, the controller 70 may perform operations (1000, 1100, 1200, 1250 and 1300) again based on the satisfaction of the water softening start condition.

According to the disclosure, the electrode 10 may be regenerated with maximum energy efficiency by operating in the power-off mode for an optimal period of time before performing the regeneration operation.

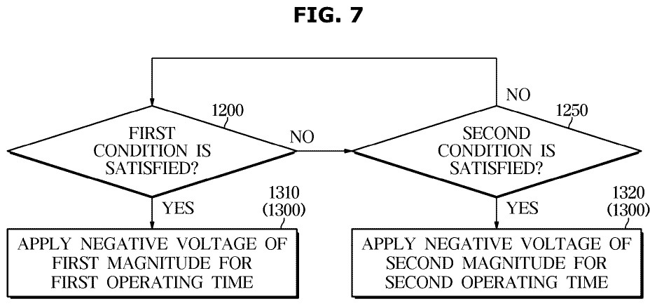

FIG. 7 is a flowchart illustrating a method in which the capacitive deionization device performs the regeneration operation according to different operating conditions according to an embodiment of the disclosure.

Referring to FIG. 7, the controller 70 may perform the regeneration operation 1310 based on the satisfaction of the first condition (yes in 1200) while operating in the power-off mode, or may perform the regeneration operation 1320 based on the satisfaction of the second condition (yes in 1250) before the first condition is satisfied.

A regeneration operation performed based on the satisfaction of the first condition is defined as a first regeneration operation, and a regeneration operation performed based on the satisfaction of the second condition is defined as a second regeneration operation.

Performing the first regeneration operation may include applying a negative voltage of first magnitude across the pair of electrodes 10 for a first operating time.

According to one embodiment, the controller 70 may apply a negative voltage having the first magnitude across the pair of electrodes 10 for the first operating time in response to performing the first regeneration operation based on the satisfaction of the first condition while operating in the power-off mode at operation 1310.

Performing the second regeneration operation may include applying a negative voltage of second magnitude across the pair of electrodes 10 for a second operating time.

According to one embodiment, the controller 70 may apply a negative voltage having the second magnitude across the pair of electrodes 10 for the second operating time in response to performing the second regeneration operation based on the satisfaction of the second condition while operating in the power-off mode at operation 1320.

According to one embodiment, the controller 70 may determine the magnitude of the negative voltage applied across the pair of electrodes 10 during the regeneration operation and the operating time of the regeneration operation based on various factors.

The magnitude of the negative voltage applied across the pair of electrodes 10 during the regeneration operation and the operating time of the regeneration operation, which are determined by the controller 70 may be referred to as a target magnitude and a target operating time, respectively.

According to one embodiment, the controller 70 may determine the target magnitude and/or the target operating time based on various factors in response to a predetermined condition (for example, the first condition or the second condition) being satisfied. Determining the target magnitude and/or the target operating time may include changing only the target operating time while maintaining the target magnitude at a predetermined magnitude, changing only the target magnitude while maintaining the target operating time at a predetermined time, and/or changing both the target magnitude and the target operating time.

According to one embodiment, the controller 70 may determine the target magnitude and/or the target operating time based on the operating time of the power-off mode in response to the predetermined condition (for example, the first condition or the second condition) being satisfied. The operating time of the power-off mode may mean a period of time from when the controller 70 starts to operate in the power-off mode until the predetermined condition is satisfied.

The controller 70 may determine the target magnitude and/or target operating time to allow the product of the target magnitude and the target operating time to decrease as the operating time of the power-off mode increases.

According to the disclosure, the longer the operating time in the power-off mode, the more natural desorption occurs, and thus the energy consumed in the regeneration operation may be reduced.

Meanwhile, because the second condition is a condition that may be satisfied ahead of the first condition in time, the operating time of the power-off mode when performing the second regeneration operation may be less than the operating time of the power-off mode when performing the first regeneration operation.

Accordingly, the product of the first magnitude and the first operating time may be less than the product of the second magnitude and the second operating time. That is, power consumed by the pair of electrodes 10 by the first regeneration operation may be less than power consumed by the pair of electrodes 10 by the second regeneration operation.

According to one embodiment, the controller 70 may determine the target magnitude and/or the target operating time based on a potential difference between the pair of electrodes 10 measured by the voltage sensor 51 in response to the predetermined condition (for example, the first condition or the second condition) being satisfied. The potential difference between the pair of electrodes 10 measured by the voltage sensor 51 may mean a potential difference between the pair of electrodes 10 measured by the voltage sensor 51 from when the controller 70 starts to operate in the power-off mode until the predetermined condition is satisfied (or referred to as an entire period of the power-off mode), or may mean a potential difference between the pair of electrodes 10 measured by the voltage sensor 51 at a time in which the predetermined condition is satisfied (or referred to as a start time of the regeneration operation).

For example, the controller 70 may determine the target magnitude and/or target operating time based on an integral value of the potential difference between the pair of electrodes 10 measured by the voltage sensor 51 during the entire period of the power-off mode or the potential difference between the pair of electrodes 10 measured by the voltage sensor 51 at the start time of the regeneration operation.

The controller 70 may determine the target magnitude and/or target operating time to allow the product of the target magnitude and the target operating time to decrease as an integral value of the potential difference between the pair of electrodes 10 measured by the voltage sensor 51 during the entire period of the power-off mode increases.

For example, the memory 72 may store a lookup table including the target magnitude and the target operating time mapped to difference values between the integral value of the potential difference between the pair of electrodes 10 measured by the voltage sensor 51 during the entire period of the power-off mode and electric energy value consumed during the entire period of the water softening operation. The controller 70 may use the lookup table to determine the target magnitude and/or the target operating time based on the difference values between the integral value of the potential difference between the pair of electrodes 10 measured by the voltage sensor 51 during the entire period of the power-off mode and the electric energy value consumed during the entire period of the water softening operation.

Meanwhile, because the second condition is a condition that may be satisfied ahead of the first condition in time, an integral value when performing the second regeneration operation may be less than an integral value when performing the first regeneration operation.

Accordingly, the product of the first magnitude and the first operating time may be less than the product of the second magnitude and the second operating time.

According to the disclosure, the greater the integral value of the potential difference between the pair of electrodes 10 measured by the voltage sensor 51 during the entire period of the power-off mode, the more natural desorption occurs. Therefore, energy consumed in the regeneration operation may be reduced.

The controller 70 may determine the target magnitude and/or target operating time to allow the product of the target magnitude and the target operating time to decrease as the potential difference between the pair of electrodes 10 measured by the voltage sensor 51 at the start time of the regeneration operation decreases.

Meanwhile, because the second condition is a condition that may be satisfied ahead of the first condition in time, the potential difference between the pair of electrodes 10 measured by the voltage sensor 51 at the start time of the second regeneration operation may be greater than the potential difference between the pair of electrodes 10 measured by the voltage sensor 51 at the start time of the first regeneration operation.

Accordingly, the product of the first magnitude and the first operating time may be less than the product of the second magnitude and the second operating time.

According to the disclosure, the smaller the potential difference between the pair of electrodes 10 measured by the voltage sensor 51 at the start time of the regeneration operation, the more natural desorption occurs. Therefore, energy consumed in the regeneration operation may be reduced.

According to one embodiment, the controller 70 may determine the target magnitude and/or the target operating time based on conductivity of the water within the third flow path 13 in response to the predetermined condition (for example, the first condition or the second condition) being satisfied. The conductivity of the water within the third flow path 13 may refer to conductivity of the water within the third flow path 13 at a point in time in which the predetermined condition is satisfied (or referred to as a start time of the regeneration operation).

Information on the conductivity of water within the third flow path 13 may be obtained through the conductivity sensor 52.

The controller 70 may determine the target magnitude and/or target operating time based on the conductivity of the water in the third flow path 13 measured by the conductivity sensor 52 at the start time of the regeneration operation.

It may be assumed that the greater the conductivity of the water in the third flow path 13, the more natural desorption occurs.

The controller 70 may determine the target magnitude and/or target operating time to allow the product of the target magnitude and the target operating time to decrease as the conductivity of the water in the third flow path 13 measured by the conductivity sensor 52 at the start time of the regeneration operation increases.

Meanwhile, because the second condition is a condition that may be satisfied ahead of the first condition in time, conductivity of the water in the third flow path 13 when performing the second regeneration operation may be less than conductivity of the water in the third flow path 13 when performing the first regeneration operation.

Accordingly, the product of the first magnitude and the first operating time may be less than the product of the second magnitude and the second operating time.

According to various embodiments, the first magnitude and the first operating time may be preset as values that may efficiently and economically promote regeneration of the electrode 10 through a plurality of experiments that considers factors such as the magnitude of the positive voltage applied to the pair of electrodes 10 in the water softening operation, the distance between the pair of electrodes 10, and the like.

Meanwhile, because the second condition is a condition that is satisfied at a start time of the next water softening operation that is unpredictable, the second magnitude and the second operating time may be determined according to various factors described above.

According to various embodiments, when the controller 70 performs the second regeneration operation, the controller 70 may determine the target magnitude and/or target operating time based on the start time of the next water softening operation.

Determining the target magnitude and/or target operating time based on the start time of the next water softening operation may include determining the target magnitude and/or target operating time based on a time interval between an end time of the water softening operation and a start time of the next water softening operation.

According to one embodiment, the controller 70 may determine the target magnitude and/or target operating time to allow the target magnitude to increase and the target operating time to decrease as the time interval between the end time of the water softening operation and the start time of the next water softening operation decreases.

The controller 70 may omit the power-off mode and immediately perform the regeneration operation in response to the time interval between the end time of the water softening operation and the start time of the next water softening operation being less than the reference time.

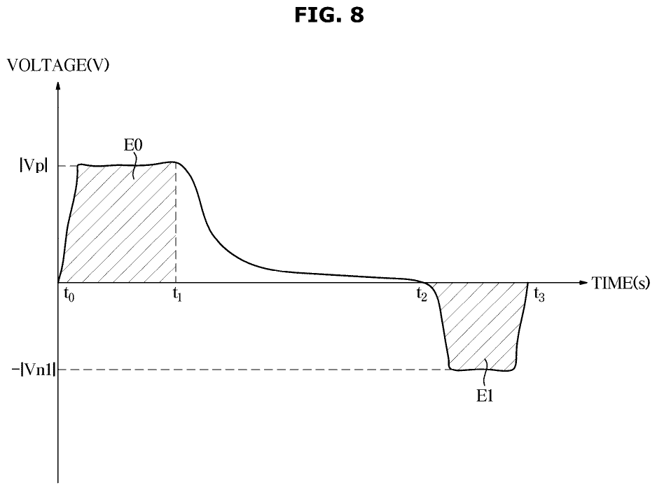

FIG. 8 is a view illustrating an example of voltage measured by a voltage sensor over time when the capacitive deionization device performs the regeneration operation based on a first condition being satisfied according to an embodiment of the disclosure.

Referring to FIG. 8, the controller 70 may perform the water softening operation by applying a positive voltage (Vp) to the pair of electrodes 10 at a time point (t0) in which the water softening start condition is satisfied.

The controller 70 may perform the power-off mode by short-circuiting or open-circuiting the pair of electrodes 10 at a time point (t1) in which the water softening termination condition is satisfied.

For example, the controller 70 may operate in the power-off mode based on an operating time (t1−t0) of the water softening operation exceeding a predetermined time or in response to electrical conductivity of the water discharged through the outlet 103 (or electrical conductivity of the water flowing in the third flow path 13) during the water softening operation exceeding a predetermined value.

The potential difference between the pair of electrodes 10 measured by the voltage sensor 51 while operating in the power-off mode may gradually decrease. Particularly, the potential difference between the pair of electrodes 10 measured by the voltage sensor 51 while operating in the power-off mode may rapidly decrease and then slowly decrease.

The controller 70 may perform the regeneration operation by applying a negative voltage (Vn1) across the pair of electrodes 10 at a time point (t2) in which the first condition is satisfied.

The product of an operating time (t3−t2) of the regeneration operation and a magnitude of the negative voltage (|Vn1|) may be less than the product of the operating time (t1−t0) of the water softening operation and the magnitude of the positive voltage (|Vp|).

The product of the operating time (t3−t2) of the regeneration operation and the magnitude of the negative voltage (|Vn1|) may correspond to a magnitude of electric energy (E1) consumed in the regeneration operation. The product of the operating time (t1−t0) of the water softening operation and the magnitude of the positive voltage (|Vp|) may correspond to a magnitude of electric energy (E0) consumed in the water softening operation.

That is, when the capacitive deionization device 1 operates in the power-off mode, the power (E1) consumed by the pair of electrodes 10 by the regeneration operation may be less than the power (E0) consumed by the pair of electrodes 10 by the water softening operation.

According to the disclosure, power consumption for the regeneration operation may be minimized by maximizing the use of the power-off mode.

As mentioned above, when the controller 70 performs the regeneration operation in response to the first condition being satisfied, the controller 70 may determine the operating time (t3−t2) of the regeneration operation and/or the magnitude of the negative voltage (|Vn1|) based on various factors such as the operating time (t2−t1) of the power-off mode, the potential difference between the pair of electrodes 10 measured by the voltage sensor 51, and the conductivity of water in the third flow path 13.

For example, when the controller 70 performs the regeneration operation in response to the first condition being satisfied, the controller 70 may determine the operating time (t3−t2) of the regeneration operation and/or the magnitude of the negative voltage (|Vn1|) based on an integral value of the potential difference measured by the voltage sensor 51 while performing the power-off mode. For example, the controller 70 may determine the operating time (t3−t2) of the regeneration operation and/or the magnitude of the negative voltage (|Vn1|) as the target time and/or the target magnitude corresponding to a value obtained by multiplying the operating time (t1−t0) of the water softening operation and the magnitude of the positive voltage (|Vp|) and a value obtained by subtracting the integral value of the potential difference measured by the voltage sensor 51 while operating in the power-off mode.

For this, the memory 72 may store a lookup table in which the value obtained by multiplying the operating time (t1−t0) of the water softening operation and the magnitude of the positive voltage (|Vp|), the value obtained by subtracting the integral value of the potential difference measured by the voltage sensor 51 while operating in the power-off mode, and the target time and/or the target magnitude corresponding thereto are mapped. As another example, the memory 72 may store an optimal algorithm for determining the target time and/or the target magnitude based on the value obtained by multiplying the operating time (t1−t0) of the water softening operation and the magnitude of the positive voltage (|Vp|) and the integral value of the potential difference measured by the voltage sensor 51 while operating in the power-off mode. In one embodiment, when the regeneration operation is performed in response to the first condition being satisfied, the operating time (t3−t2) of the regeneration operation and the magnitude of the negative voltage (|Vn1|) may be preset as the optimal target time and optimal target magnitude, and stored in the memory 72.

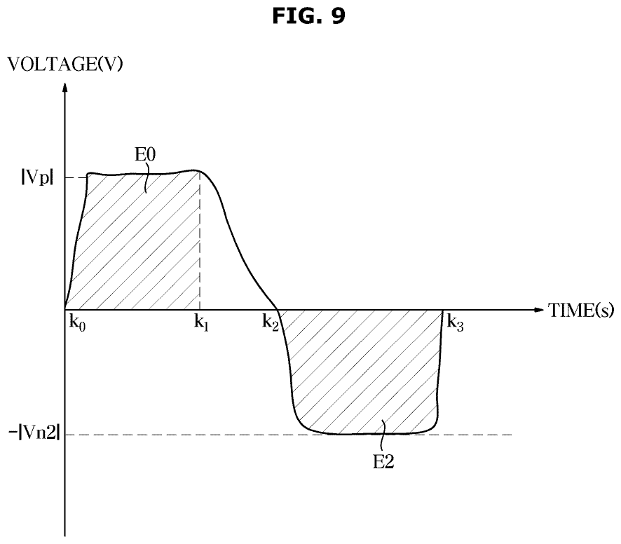

FIG. 9 is a view illustrating an example of voltage measured by the voltage sensor over time when the capacitive deionization device performs the regeneration operation based on a second condition being satisfied according to an embodiment of the disclosure.

Referring to FIG. 9, the controller 70 may perform the water softening operation by applying a positive voltage (Vp) to the pair of electrodes 10 at a time point (k0) in which the water softening start condition is satisfied.

The controller 70 may perform the power-off mode by short-circuiting or open-circuiting the pair of electrodes 10 at a time point (k1) in which the water softening termination condition is satisfied.

For example, the controller 70 may perform the power-off mode based on an operating time (k1−k0) of the water softening operation exceeding a predetermined time or in response to electrical conductivity of the water discharged through the outlet 103 (or electrical conductivity of the water flowing in the third flow path 13) during the water softening operation exceeding a predetermined value.

The potential difference between the pair of electrodes 10 measured by the voltage sensor 51 while operating in the power-off mode may gradually decrease.

The controller 70 may perform the regeneration operation by applying a negative voltage (Vn2) across the pair of electrodes 10 based on the satisfaction of the second condition while operating in the power-off mode.

For example, when it is required to start the regeneration operation at a time point (k3), which is earlier than the time point (t3) in FIG. 8, the controller 70 may start the regeneration operation according to the satisfaction of the second condition even when the first condition is not satisfied.

The time point (k3) may correspond to a start time of the next water softening operation.

At the time point (k2), the controller 70 may start the regeneration operation based on a time interval (k3−k2) between the start time (k3) of the next water softening operation and a current time (k2) reaching the reference time.

The product of an operating time (k3−k2) of the regeneration operation and a magnitude of the negative voltage (|Vn2|) may be less than the product of the operating time (t1−t0) of the water softening operation and the magnitude of the positive voltage (|Vp|).

That is, when the power-off mode is performed, power (E2) consumed by the pair of electrodes 10 by the regeneration operation may be less than power (E0) consumed by the pair of electrodes 10 by the water softening operation.

However, the power (E2) consumed by the pair of electrodes 10 when performing the second regeneration operation based on the satisfaction of the second condition may be greater than the power (E1 in FIG. 8) consumed by the pair of electrodes 10 when performing the first regeneration operation based on the satisfaction of the first condition.

For example, the controller 70 may perform a regeneration operation, which applies the negative voltage (Vn1) having the first magnitude (|Vn1| in FIG. 8) across the pair of electrodes 10, for the first operating time (t3-t2 in FIG. 8) based on the first condition being satisfied while operating in the power-off mode. The controller 70 may perform a regeneration operation, which applies a negative voltage (Vn2) having a second magnitude (|Vn2| in FIG. 9) across the pair of electrodes 10, for a second operating time (k3−k2 in FIG. 9) based on the second condition being satisfied while operating in the power-off mode. The product of the second magnitude (|Vn2| in FIG. 9) and the second operating time (k3−k2 in FIG. 9) may be greater than the product of the first magnitude (|Vn1| in FIG. 8) and the first operating time (t3−t2 in FIG. 8).

As mentioned above, when the controller 70 performs the regeneration operation in response to the second condition being satisfied, the controller 70 may determine the operating time (k3-k2) of the regeneration operation and/or the magnitude of the negative voltage (|Vn2|) based on various factors such as the operating time (k2-k1) of the power-off mode, the potential difference between the pair of electrodes 10 measured by the voltage sensor 51, and the conductivity of water in the third flow path 13.

For example, when the controller 70 performs the regeneration operation in response to the second condition being satisfied, the controller 70 may determine the regeneration operating time (k3−k2) and the magnitude of the negative voltage (|Vn2|) to allow the product of the operating time (k3−k2) of the regeneration operation and the magnitude of the negative voltage (|Vn2|) to increase as the operating time (k2−k1) of the power-off mode decreases.

When the controller 70 performs the regeneration operation in response to the second condition being satisfied, the controller 70 may determine the operating time (k3−k2) of the regeneration operation and/or the magnitude of the negative voltage (|Vn2|) based on an integral value of the potential difference measured by the voltage sensor 51 while operating in the power-off mode.

For example, the controller 70 may determine the operating time (k3−k2) of the regeneration operation and the magnitude of the negative voltage (|Vn2|) to allow a value obtained by multiplying the operating time (k3−k2) of the regeneration operation and the magnitude of the negative voltage (|Vn2|) to corresponds to a value obtained by subtracting the integral value of the potential difference measured by the voltage sensor 51 while performing the power-off mode from the integral value of the potential difference measured by the voltage sensor 51 while performing the water softening operation.

When the controller 70 performs the regeneration operation in response to an early water softening condition (e.g. the second condition) being satisfied, the controller 70 may determine the operating time (k3−k2) of the regeneration operation and the magnitude of the negative voltage (|Vn2|) based on the conductivity of the water in the water softening flow path 13.

For example, when the controller 70 performs the regeneration operation in response to the second condition being satisfied, the controller 70 may determine the operating time (k3−k2) of the regeneration operation and the magnitude of the negative voltage (|Vn2|) to allow the product of the operating time (k3−k2) of the regeneration operation and the magnitude of the negative voltage (|Vn2|) to increase as the conductivity of the water in the water softening flow path 13 decreases.

According to one embodiment, the controller 70 may omit the power-off mode and immediately perform the regeneration operation in response to the start time (k3) of the next water softening operation being within the reference time after the termination of the water softening operation.

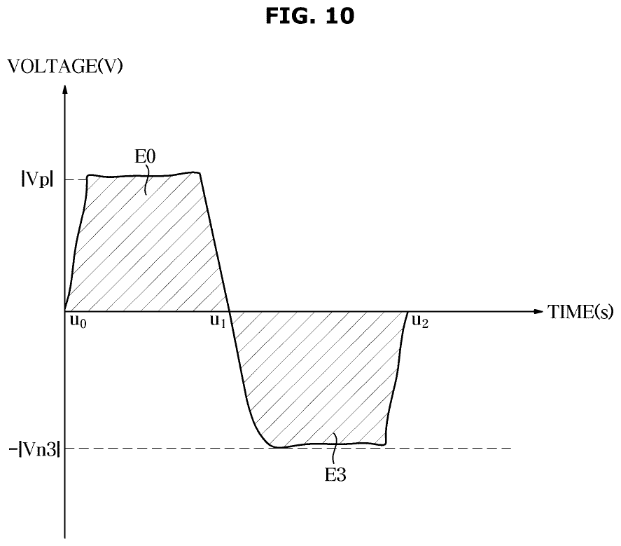

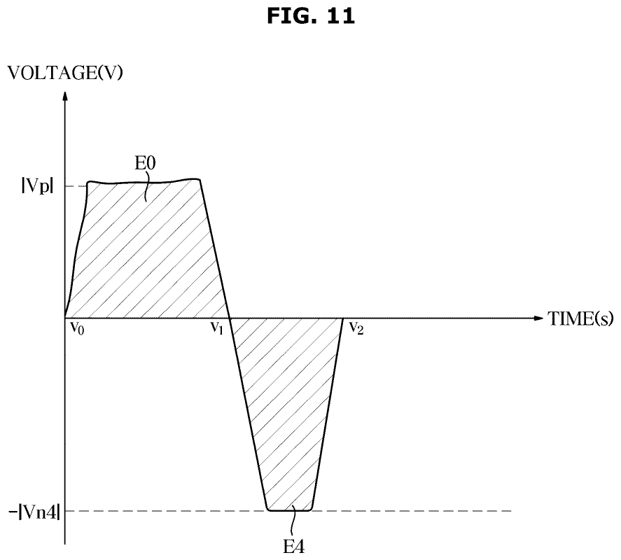

FIG. 10 is a view illustrating an example of voltage measured by the voltage sensor over time when the capacitive deionization device omits the power-off mode and performs the regeneration operation according to an embodiment of the disclosure. FIG. 11 is a view illustrating another example of voltage measured by the voltage sensor over time when the capacitive deionization device omits the power-off mode and performs the regeneration operation according to an embodiment of the disclosure.

Referring to FIGS. 10 and 11, the controller 70 may perform the water softening operation by applying a positive voltage (Vp) to the pair of electrodes 10 at a time point (u0 and v0) in which the water softening start condition is satisfied.

The controller 70 may determine whether a time interval between the end time (u1 and v1) of the water softening operation and the start time (u2 and v2) of the next water softening operation is less than or equal to the reference time.

The controller 70 may omit the power-off mode and start the regeneration operation in response to the time interval (u2−u1 and v2−v1) between the end time (u1 and v1) of the water softening operation and the start time (u2 and v2) of the next water softening operation being less than or equal to the reference time. The reference time may correspond to an entire period (u1−u0 and v1−v0) of the water softening operation.

The controller 70 may determine an operating time (u2−u1 and v2−v1) of the regeneration operation and/or a magnitude of the negative voltage (|Vn3| and |Vn4|) based on the time interval (u2−u1 and v2−v1) between the end time (u1 and v1) of the water softening operation and the start time (u2 and v2) of the next water softening operation.

For example, in response to the time interval (u2−u1 and v2−v1) between the end time (u1 and v1) of the water softening operation and the start time (u2 and v2) of the next water softening operation being less than or equal to the entire period of the water softening operation (u1−u0 and v1−v0), the controller 70 may determine the operating time of the regeneration operation as the time interval between the end time (u1 and v1) of the water softening operation and the start time (u2 and v2) of the next water softening operation, and determine the magnitude of the negative voltage.

According to one embodiment, the controller 70 may determine the operating time (u2−u1) of the regeneration operation as the entire period (u1−u0) of the water softening operation in response to the time interval (u2−u1) between the end time (u1) of the water softening operation and the start time (u2) of the next water softening operation being equal to the reference time (u1−u0).

According to one embodiment, the controller 70 may determine the magnitude of the negative voltage (|Vn3|) as the magnitude of the positive voltage (|Vp|) in response to the time interval (u2−u1) between the end time (u1) of the water softening operation and the start time (u2) of the next water softening operation being equal to the reference time (u1−u0).

That is, when the power-off mode is omitted, power (E3) consumed by the pair of electrodes 10 by the regeneration operation may be equal to the power (E0) consumed by the pair of electrodes 10 by the water softening operation.

According to the disclosure, the time interval (u2−u1) between the end time (u1) of the water softening operation and the start time (u2) of the next water softening operation being equal to the reference time may include that the difference between the time interval (u2−u1) between the end time (u1) of the water softening operation and the start time (u2) of the next water softening operation and the reference time (u1−u0) is within a predetermined range (for example, 10 seconds).

According to one embodiment, the controller 70 may determine the operating time (v2−v1) of the regeneration operation to be shorter than the entire period (u1−u0) of the water softening operation in response to the time interval (v2−v1) between the end time (v1) of the water softening operation and the start time (v2) of the next water softening operation being less than the reference time (v1−v0). For example, the controller 70 may determine the operating time of the regeneration operation to allow the regeneration operation to be terminated before the start time (v2) of the next water softening operation.

According to one embodiment, the controller 70 may determine a magnitude of the negative voltage (|Vn4|) to be greater than the magnitude of the positive voltage (|Vp|) in response to the time interval (v2−v1) between the end time (v1) of the water softening operation and the start time (v2) of the next water softening operation being less than the reference time (v1−v0). For example, the controller 70 may determine the magnitude of the negative voltage (|Vn4|) to allow the product of the operating time of the regeneration operation and the magnitude of the negative voltage (|Vn4|) to be equal to the product of the operating time (v1−v0) of the water softening operation and the magnitude of the positive voltage (|Vp|).

As mentioned above, when the operating time of the regeneration operation and the magnitude of the negative voltage (|Vn4|) are determined, power (E4) consumed by the pair of electrodes 10 by the regeneration operation may be equal to the power (E0) consumed by the pair of electrodes 10 by the water softening operation.

According to the disclosure, when the start time of the next water softening operation is within the reference time, the power-off mode may be omitted to allow the water softening operation to proceed at the start time of the next water softening operation. Accordingly, user inconvenience may be reduced.

The capacitive deionization device 1 according to one embodiment of the disclosure may include the pair of electrodes 10, and the controller 70 configured to perform the water softening operation that applies a positive voltage across the pair of electrodes 10, configured to operate in the power-off mode that short-circuits or open-circuits the pair of electrodes 10 based on termination of the water softening operation, and configured to perform the regeneration operation that applies a negative voltage across pair of electrodes 10 based on satisfaction of a predetermined condition while operating in the power-off mode.

The product of an operating time of the regeneration operation and a magnitude of the negative voltage may be less than the product of an operating time of the water softening operation and a magnitude of the positive voltage.

The capacitive deionization device 1 may further include the voltage sensor 51 configured to measure a potential difference between the pair of electrodes.

The predetermined condition may include at least one of a potential difference measured by the voltage sensor 51 in the power-off mode reaching 0 V or a rate of change of a potential difference measured by the voltage sensor 51 reaching 0 (zero).

The predetermined condition may include the first condition and the second condition. The controller 70 may be configured to apply the negative voltage having a first magnitude across the pair of electrodes 10 for a first operating time in response to the regeneration operation being performed based on the satisfaction of the first condition, and configured to apply the negative voltage having a second magnitude across the pair of electrodes 10 for a second operating time in response to the regeneration operation being performed based on the satisfaction of the second condition before the satisfaction of the first condition.

The product of the second magnitude and the second operating time may be greater than the product of the first magnitude and the first operating time.

The first condition may include at least one of a condition related to the potential difference between the pair of electrodes 10 or a condition related to an operating time of the power-off mode.

The second condition may include a condition related to the start time of the next water softening operation.

In response to the regeneration operation being performed based on the satisfaction of the second condition, the controller 70 may be configured to determine at least one of the magnitude of the negative voltage or the operating time of the regeneration operation based on the start time of the next water softening operation.

The controller 70 may be configured to determine at least one of the magnitude of the negative voltage or the operating time of the regeneration operation based on an operating time of the power-off mode.

The controller 70 may be configured to determine at least one of the magnitude of the negative voltage or the operating time of the regeneration operation based on the potential difference between the pair of electrodes 10 measured by the voltage sensor 51.

The controller 70 may be configured to determine at least one of the magnitude of the negative voltage or the operating time of the regeneration operation based on an integral value of the potential difference measured by the voltage sensor 50 during an entire period of the power-off mode or the potential difference measured by the voltage sensor 51 at the start time of the regeneration operation.

The controller 70 may be configured to determine at least one of the magnitude of the negative voltage and the operating time of the regeneration operation based on conductivity of water in a channel formed between the pair of electrodes 10.

The capacitive deionization device 1 may further include the discharge flow path provided to discharge water flowing along the channel formed between the pair of electrodes 10 to the outside of the capacitive deionization device 1, and the valve configured to open and close the discharge flow path,

The controller 70 may be configured to control the valve to open the discharge flow path in the water softening operation and the regeneration operation.

The controller 70 may be configured to control the valve to close the discharge flow path in the power-off mode.

The control method of the capacitive deionization device 1 according to one embodiment of the disclosure may include performing the water softening operation that applies a positive voltage across the pair of electrodes 10, operating in the power-off mode that short-circuits or open-circuits the pair of electrodes 10 based on termination of the water softening operation, and performing the regeneration operation that applies a negative voltage across the pair of electrodes 10 based on satisfaction of the predetermined condition while operating in the power-off mode.

The performing of the regeneration operation may include applying the negative voltage having a first magnitude across the pair of electrodes 10 for a first operating time in response to the regeneration operation being performed based on the satisfaction of the first condition, and applying the negative voltage having a second magnitude across the pair of electrodes 10 for a second operating time in response to the regeneration operation being performed based on the satisfaction of the second condition before the satisfaction of the first condition.

The control method of the capacitive deionization device 1 may further include, in response to the regeneration operation being performed based on the satisfaction of the second condition, determining at least one of the magnitude of the negative voltage or the operating time of the regeneration operation based on the start time of the next water softening operation.

The control method of the capacitive deionization device 1 may further include determining at least one of the magnitude of the negative voltage or the operating time of the regeneration operation based on an operating time of the power-off mode.

The control method of the capacitive deionization device 1 may further include determining at least one of the magnitude of the negative voltage or the operating time of the regeneration operation based on the potential difference between the pair of electrodes 10 measured by the voltage sensor 51.

The determining at least one of the magnitude of the negative voltage or the operating time of the regeneration operation based on the potential difference between the pair of electrodes 10 measured by the voltage sensor 51 may include determining at least one of the magnitude of the negative voltage or the operating time of the regeneration operation based on an integral value of the potential difference measured by the voltage sensor 51 during an entire period of the power-off mode or the potential difference measured by the voltage sensor 51 at a start time of the regeneration operation.

The control method of the capacitive deionization device 1 may further include determining at least one of the magnitude of the negative voltage and the operating time of the regeneration operation based on conductivity of water in a channel formed between the pair of electrodes 10.

The control method of the capacitive deionization device 1 may further include opening the discharge flow path, which is provided to discharge water flowing along the channel formed between the pair of electrodes 10 to the outside of the capacitive deionization device 1, in the water softening operation and the regeneration operation.

The control method of the capacitive deionization device 1 may further include closing the discharge flow path in the power-off mode.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be read only memory (ROM), random access memory (RAM), a magnetic tape, a magnetic disk, flash memory, and an optical data storage device.

Storage medium readable by machine, may be provided in the form of a non-transitory storage medium. “Non-transitory storage medium” means that the storage medium is a tangible device and does not contain a signal (e.g., electromagnetic wave), and this term includes a case in which data is semi-permanently stored in a storage medium and a case in which data is temporarily stored in a storage medium. For example, “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non−volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those of skilled in the art that various changes in form and details may be made without departing from the spirit and scope of the disclosure as defined by the appended claims and their equivalents.

1. A capacitive deionization device comprising:
a pair of electrodes; and
a controller configured to:
perform a water softening operation that applies a positive voltage across the pair of electrodes,
operate in a power-off mode that short-circuits or open-circuits the pair of electrodes based on termination of the water softening operation, and
perform a regeneration operation that applies a negative voltage across the pair of electrodes based on satisfaction of a predetermined condition while operating in the power-off mode,
wherein a product of an operating time of the regeneration operation and a magnitude of the negative voltage is less than a product of an operating time of the water softening operation and a magnitude of the positive voltage.

2. The capacitive deionization device of claim 1, further comprising:
a voltage sensor configured to measure a potential difference between the pair of electrodes,
wherein the predetermined condition comprises: at least one of the potential difference measured by the voltage sensor in the power-off mode reaching 0 V or a rate of change of the potential difference measured by the voltage sensor reaching 0 (zero).

3. The capacitive deionization device of claim 1,
wherein the predetermined condition comprises: a first condition and a second condition,
wherein the controller is:
configured to apply the negative voltage having a first magnitude across the pair of electrodes for a first operating time in response to the regeneration operation being performed based on the satisfaction of the first condition; and
configured to apply the negative voltage having a second magnitude across the pair of electrodes for a second operating time in response to the regeneration operation being performed based on the satisfaction of the second condition before the satisfaction of the first condition, and
wherein a product of the second magnitude and the second operating time is greater than a product of the first magnitude and the first operating time.

4. The capacitive deionization device of claim 3,
wherein the first condition comprises:
at least one of a condition related to a potential difference between the pair of electrodes or a condition related to an operating time of the power-off mode, and
wherein the second condition comprises:
a condition related to a start time of a next water softening operation.

5. The capacitive deionization device of claim 4, wherein in response to the regeneration operation being performed based on the satisfaction of the second condition, the controller is configured to determine at least one of the magnitude of the negative voltage or the operating time of the regeneration operation based on the start time of a next water softening operation.

6. The capacitive deionization device of claim 1, wherein the controller is configured to determine at least one of the magnitude of the negative voltage or the operating time of the regeneration operation based on an operating time of the power-off mode.

7. The capacitive deionization device of claim 1, further comprising:
a voltage sensor configured to measure a potential difference between the pair of electrodes,
wherein the controller is configured to determine at least one of the magnitude of the negative voltage or the operating time of the regeneration operation based on the potential difference between the pair of electrodes measured by the voltage sensor.

8. The capacitive deionization device of claim 7, wherein the controller is configured to determine at least one of the magnitude of the negative voltage or the operating time of the regeneration operation based on an integral value of the potential difference measured by the voltage sensor during an entire period of the power-off mode or the potential difference measured by the voltage sensor at a start time of the regeneration operation.

9. The capacitive deionization device of claim 1, wherein the controller is configured to determine at least one of the magnitude of the negative voltage or the operating time of the regeneration operation based on conductivity of water in a channel formed between the pair of electrodes.

10. The capacitive deionization device of claim 1, further comprising:
a discharge flow path provided to discharge water flowing along a channel formed between the pair of electrodes to an outside of the capacitive deionization device; and
a valve configured to open and close the discharge flow path,
wherein the controller is configured to:
control the valve to open the discharge flow path in the water softening operation and the regeneration operation; and
control the valve to close the discharge flow path in the power-off mode.

11. A method performed by a capacitive deionization device comprising:
performing a water softening operation that applies a positive voltage across a pair of electrodes;
operating in a power-off mode that short-circuits or open-circuits the pair of electrodes based on termination of the water softening operation; and
performing a regeneration operation that applies a negative voltage across the pair of electrodes based on satisfaction of a predetermined condition while operating in the power-off mode,
wherein a product of an operating time of the regeneration operation and a magnitude of the negative voltage is less than a product of an operating time of the water softening operation and a magnitude of the positive voltage.

12. The method of claim 11,
wherein the capacitive deionization device comprises: a voltage sensor configured to measure a potential difference between the pair of electrodes, and
wherein the predetermined condition comprises: at least one of a potential difference measured by the voltage sensor in the power-off mode reaching 0 V or a rate of change of a potential difference measured by the voltage sensor reaching 0 (zero).

13. The method of claim 11,
wherein the predetermined condition comprises: a first condition and a second condition,
wherein the performing of the regeneration operation comprises:
applying the negative voltage having a first magnitude across the pair of electrodes for a first operating time in response to the regeneration operation being performed based on the satisfaction of the first condition; and
applying the negative voltage having a second magnitude across the pair of electrodes for a second operating time in response to the regeneration operation being performed based on the satisfaction of the second condition before the satisfaction of the first condition, and
wherein a product of the second magnitude and the second operating time is greater than a product of the first magnitude and the first operating time.

14. The method of claim 13,
wherein the first condition comprises:
at least one of a condition related to a potential difference between the pair of electrodes or a condition related to an operating time of the power-off mode, and
wherein the second condition comprises:
a condition related to a start time of a next water softening operation.

15. The method of claim 14, further comprising:
in response to the regeneration operation being performed based on the satisfaction of the second condition, determining at least one of the magnitude of the negative voltage or the operating time of the regeneration operation based on the start time of the next water softening operation.
